(19) United States
(12) Patent Application Publication
(10) Pub. No.: US 2024/0365028 A1
(43) Pub. Date: Oct. 31, 2024

(54) WAVELENGTH SELECTIVE SWITCH AND OPTICAL CROSS-CONNECT DEVICE INCLUDING WAVELENGTH SELECTIVE SWITCH

(71) Applicant: FUJIFILM Corporation, Tokyo (JP)

(72) Inventors: Makoto KAMO, Minamiashigara-shi (JP); Yukito SAITOH, Minamiashigara-shi (JP)

(73) Assignee: FUJIFILM Corporation, Tokyo (JP)

(21) Appl. No.: 18/766,931

(22) Filed: Jul. 9, 2024

Related U.S. Application Data
(63) Continuation of application No. PCT/JP2022/047530, filed on Dec. 23, 2022.

(30) Foreign Application Priority Data
Jan. 17, 2022 (JP) 2022-005113
Nov. 21, 2022 (JP) 2022-185429

(51) Int. Cl. H04Q 11/00; G02B 6/35

(52) U.S. Cl. CPC H04Q 11/0005; G02B 6/3534; G02B 6/3548; H04Q 2011/0016; H04Q 2011/0049

(57) ABSTRACT

Provided are a wavelength selective switch capable of dealing with a broadband wavelength range with reduced crosstalk and an optical cross-connect device including the wavelength selective switch. The wavelength selective switch includes an optical input port; an optical output port; a wavelength dispersion unit that spatially separates light incident from the optical input port for each of wavelengths and emits the separated light such that an emission angle of the incident light varies for each of predetermined wavelength ranges; and a deflection unit that couples light incident from the wavelength dispersion unit to the optical output port by deflecting the incident light such that a reflection angle or a transmission angle of the incident light is variable for each of wavelengths, in which the wavelength dispersion unit includes a wavelength dispersive element and a position control mechanism that reversibly changes a position or an angle of the wavelength dispersive element or both the position and the angle with respect to the optical input port.

### CROSS-REFERENCE TO RELATED APPLICATIONS

This application is a Continuation of PCT International Application No. PCT/JP2022/047530 filed on Dec. 23, 2022, which claims priority under 35 U.S.C. § 119(a) to Japanese Patent Application No. 2022-005113 filed on Jan. 17, 2022 and Japanese Patent Application No. 2022-185429 filed on Nov. 21, 2022. The above applications are hereby expressly incorporated by reference, in their entirety, into the present application.

### BACKGROUND OF THE INVENTION

### 1. Field of the Invention

The present invention relates to a wavelength selective switch and an optical cross-connect device including the wavelength selective switch.

### 2. Description of the Related Art

In the related art, a wavelength cross-connect device is connected as a relay node of an optical signal to an optical fiber of a route (optical transmission line) where a plurality of optical fibers of an optical network are bundled. In the wavelength cross-connect device, optical signals from routes on an input side are output to predetermined routes on an output side through a plurality of wavelength selective switches (WSS).

The wavelength selective switch has a function of separating wavelength components in an optical signal transmitted through an optical fiber in wavelength multiplexing communication from each other and distributing each of the separated wavelength components to a predetermined route. For the separation of the wavelength components, a dispersive element is used, and the distribution to the route can be performed by spatially separating differences in wavelength. As the dispersive element, for example, a prism, a surface relief diffraction grating (surface relief grating: SRG), or an arrayed waveguide diffraction grating (arrayed waveguide grating: AWG)) is used.

For example, JP2017-152749A describes an optical cross-connect device that is disposed in an optical node of an optical network where optical nodes are connected to each other through each of a plurality of optical fibers for internode connection, the optical cross-connect device including: an input port for internode connection and an output port for internode connection that are connected to each of the plurality of optical fibers for internode connection; and a plurality of optical cross-connect units each of which includes an input port for internal connection and an output port for internal connection and that are connected to each other annularly or in series through the input port for internal connection and the output port for internal connection, in which each of the plurality of optical cross-connect units is configured by a single wavelength selective switch including a plurality of inputs corresponding to the numbers of the input ports for internode connection and the input ports for internal connection and a plurality of outputs corresponding to the numbers of the output ports for internode connection and the output ports for internal connection.

### SUMMARY OF THE INVENTION

A multiplex communication mode has been investigated in various ways. However, regarding the wavelength multiplexing mode, only the C-band (1530 nm to 1565 nm) is mainly used, and the utilization of the other bands is expected as resources for improving the communication speed.

In a case where a broadband wavelength range is adopted, the wavelength selective switch used in the optical cross-connect device also needs to deal with the broadband wavelength range. However, a physical size of a spatial modulator used for switching has an upper limit, and thus in a case where it is attempted to cover all the bands with one wavelength selective switch, spatial separation is insufficient, and crosstalk may deteriorate.

Accordingly, an object of the present invention is to provide a wavelength selective switch capable of dealing with a broadband wavelength range with reduced crosstalk and an optical cross-connect device including the wavelength selective switch.

The present inventors found that the object can be achieved by the following configurations.

[1] A wavelength selective switch comprising:
an optical input port;
an optical output port;
a wavelength dispersion unit that spatially separates light incident from the optical input port for each of wavelengths and emits the separated light such that an emission angle of the incident light varies for each of predetermined wavelength ranges; and
a deflection unit that couples light incident from the wavelength dispersion unit to the optical output port by deflecting the incident light such that a reflection angle or a transmission angle of the incident light is variable for each of wavelengths,
in which the wavelength dispersion unit includes a wavelength dispersive element and a position control mechanism that reversibly changes a position or an angle of the wavelength dispersive element or both the position and the angle with respect to the optical input port.

The wavelength selective switch according to [1], further comprising:
a multiplexing unit that multiplexes two or more of light components having wavelengths deflected by the deflection unit.

The wavelength selective switch according to [2],
in which the wavelength dispersion unit also functions as the multiplexing unit.

The wavelength selective switch according to [1],
in which the wavelength dispersive element includes at least one of a prism, a surface relief diffraction grating, or a liquid crystal diffraction element.

The wavelength selective switch according to [4],
in which the wavelength dispersive element is a liquid crystal diffraction element that includes an optically-anisotropic layer having a liquid crystal alignment pattern where an orientation of an optical axis derived from a liquid crystal compound changes while continuously rotating in at least one in-plane direction.

An optical cross-connect device comprising:
the wavelength selective switch according to any one of [1] to [5].

According to the present invention, a wavelength selective switch capable of operating a broadband wavelength range with reduced crosstalk can be provided.

In addition, according to the present invention, an optical cross-connect device including the wavelength selective switch can be provided.

### BRIEF DESCRIPTION OF THE DRAWINGS

FIG. 1 is a conceptual diagram showing one example of a wavelength selective switch according to the present invention.

FIG. 2a is a conceptual diagram showing one example of a wavelength selective switch in the related art.

FIG. 2b is a conceptual diagram showing one example of a wavelength selective switch according to the present invention.

FIG. 3 is a conceptual diagram showing an example of a liquid crystal diffraction element used in the present invention.

FIG. 4 is a conceptual diagram showing an example of a liquid crystal diffraction element used in the wavelength selective switch according to the present invention.

FIG. 5 is a conceptual plan view showing the liquid crystal diffraction element shown in FIG. 3.

FIG. 6 is a conceptual diagram showing an example of an exposure device that exposes an alignment film of the liquid crystal diffraction element shown in FIG. 3.

FIG. 7 is a conceptual diagram showing another example of the liquid crystal diffraction element used in the wavelength selective switch according to the present invention.

### DESCRIPTION OF THE PREFERRED EMBODIMENTS

Hereinafter, the details of the present invention will be described.

The following description regarding configuration requirements has been made based on a representative embodiment of the present invention. However, the present invention is not limited to the embodiment.

In the present specification, a numerical range expressed using “to” refers to a range including numerical values described before and after “to” as a lower limit value and an upper limit value.

### <Wavelength Selective Switch>

A wavelength selective switch according to an embodiment of the present invention comprises:
an optical input port;
an optical output port;
a wavelength dispersion unit that spatially separates light incident from the optical input port for each of wavelengths and emits the separated light such that an emission angle of the incident light varies for each of predetermined wavelength ranges; and
a deflection unit that couples light incident from the wavelength dispersion unit to the optical output port by deflecting the incident light such that a reflection angle or a transmission angle of the incident light is variable for each of wavelengths,
in which the wavelength dispersion unit includes a wavelength dispersive element and a position control mechanism that reversibly changes a position or an angle of the wavelength dispersive element or both the position and the angle with respect to the optical input port.

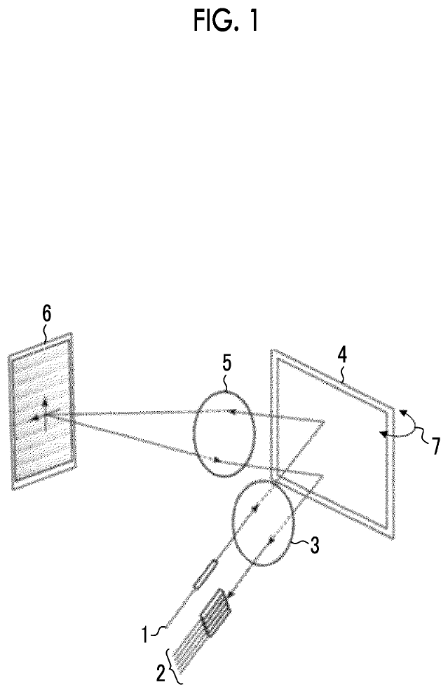

FIG. 1 shows a configuration of a wavelength selective switch according to one preferable embodiment of the present invention. FIG. 1 shows an example of a drop wavelength selective switch including one optical input port 1 and a plurality of optical output ports 2. Regarding an add wavelength selective switch, only an input/output direction of light is reversed, and the description thereof is mostly the same as that of the drop type and thus will not be repeated. However, the present invention is also applicable to the add wavelength selective switch including a plurality of optical input ports and one optical output port. In addition, although not described below in detail, an add-drop wavelength selective switch including a plurality of optical input ports and a plurality of optical output ports may also be adopted.

The spatial optical wavelength selective switch shown in FIG. 1 including the optical input port 1 and the plurality of optical output ports 2 includes a deflection unit 6 and a wavelength dispersion unit that spatially separates light incident from the optical input port 1 for each of wavelengths and emits the separated light such that an emission angle of the incident light varies for each of predetermined wavelength ranges. The wavelength dispersion unit has a function of multiplexing light deflected by and incident from the deflection unit and coupling the light to the optical output ports 2.

The wavelength dispersion unit includes: a wavelength dispersive element 4 such as a prism or a diffraction grating for demultiplexing and multiplexing incidence light; and a position control mechanism 7 that reversibly changes a position or an angle of the wavelength dispersive element 4 or both the position and the angle with respect to the optical input port 1. In the example shown in FIG. 1, the position control mechanism 7 reversibly changes an angle of a main surface of the wavelength dispersive element 4 with respect to an optical axis direction (emission direction of light) of the optical input port 1. That is, the position control mechanism 7 reversibly changes an incidence angle at which light incident from the optical input port 1 is incident into the wavelength dispersive element 4. In addition, in the example shown in the drawing, optionally, the wavelength dispersion unit may further include a front-end optical system 3 that is present between the optical input port 1 and the wavelength dispersive element 4 and/or a back-end optical system 5 that is present between the wavelength dispersive element 4 and the deflection unit 6.

In the wavelength selective switch shown in FIG. 1, light incident from the optical input port 1 transmits through the front-end optical system 3, the wavelength dispersive element 4, and the back-end optical system 5, is reflected from the deflection unit 6, transmits through the back-end optical system 5, the wavelength dispersive element 4, and the front-end optical system 3 again, and is coupled to the plurality of optical output ports 2.

The wavelength selective switch shown in FIG. 1 separates wavelength components in an optical signal incident in wavelength multiplexing communication from each other, and distributes each of the separated wavelength components to a predetermined route.

In the wavelength selective switch shown in FIG. 1, the light incident from the optical input port 1 is incident into the wavelength dispersive element 4 after a polarization state, a traveling direction, and the like of the light are adjusted by the front-end optical system 3. The wavelength dispersive element 4 separates incident light into each of wavelength components, and reflects the light toward the deflection unit 6. The light that is separated into each of the wavelength components by the wavelength dispersive element 4 is incident into the deflection unit 6 after a polarization state, a traveling direction, and the like of the light are adjusted by the back-end optical system 5. The deflection unit 6 deflects the incident light having each of the wavelength components in a desired direction for each of the wavelengths. The light having each of the wavelength components that is deflected by the deflection unit 6 is incident into the wavelength dispersive element 4 after a polarization state, a traveling direction, and the like of the light are adjusted by the back-end optical system 5. The wavelength dispersive element 4 reflects the light having each of the wavelength components toward a desired optical output port 2. In this case, the wavelength dispersive element 4 multiplexes light components having desired wavelength components among the light components having the wavelength components. That is, in the example shown in the drawing, the wavelength dispersive element 4 (wavelength dispersion unit) also functions as a multiplexing unit. The light reflected from the wavelength dispersive element 4 is coupled to the plurality of optical output ports 2 after polarization states, traveling directions, and the like are adjusted by the front-end optical system 3.

In the example shown in FIG. 1, the wavelength dispersive element 4 is configured to also function as a multiplexing unit that multiplexes light components having desired wavelength components among the light components having the wavelength components deflected by the deflection unit 6. However, the present invention is not limited to this configuration. The wavelength selective switch according to the embodiment of the present invention may be configured to couple the light components having the wavelength components to different optical output ports without having the function of multiplexing the light components having the wavelength components deflected by the deflection unit 6. Alternatively, the wavelength selective switch according to the embodiment of the present invention may be configured to include a multiplexing unit separately from the wavelength dispersive element 4.

In the example shown in FIG. 1, the plurality of optical output ports 2 are arranged substantially in the vertical direction in the drawing, the wavelength dispersive element 4 separates light incident from the optical input port 1 substantially in the horizontal direction in the drawing, and the deflection unit 6 deflects the light having each of the wavelength components substantially in the vertical direction in the drawing to couple the light to the desired optical output port 2. That is, in a view from a traveling direction of light, the direction in which the deflection unit 6 deflects the light is the direction in which the plurality of optical output ports 2 are arranged, and the direction in which the wavelength dispersive element 4 separates the light is a direction substantially orthogonal to the direction in which the deflection unit 6 deflects the light.

For example, five wavelength components in light incident from the optical input port 1 contain different signals, and in a case where, among the five signals, first and second wavelength components are output to a first optical output port, third and fourth wavelength components are output to a second optical output port, and a fifth wavelength component is output to a third optical output port, the wavelength dispersive element 4 separates the incident light into five wavelength components. In addition, among the five wavelength components, the deflection unit 6 deflects the first and second wavelength components in a direction toward the first optical output port, deflects the third and fourth wavelength components in a direction toward the second optical output port, and deflects the fifth wavelength component in a direction toward the third optical output port. The wavelength dispersive element 4 multiplexes the first and second wavelength components deflected by the deflection unit 6 to couple the multiplexed light to the first optical output port, multiplexes the third and fourth wavelength components to couple the multiplexed light to the second optical output port, and couples the fifth wavelength component to the third optical output port.

This way, in the wavelength multiplexing communication where wavelengths contain different signals, the wavelength selective switch separates wavelength components in an incident optical signal from each other, and distributes each of the separated wavelength components to a predetermined route.

Here, in the present invention, the wavelength dispersion unit includes the position control mechanism 7 that reversibly changes a position or an angle of the wavelength dispersive element 4 or both the position and the angle with respect to the optical input port 1. The wavelength selective switch according to the embodiment of the present invention can change the wavelength range of light to be separated by the wavelength dispersive element 4 by changing the position and/or the angle of the wavelength dispersive element 4. As a result, the wavelength selective switch according to the embodiment of the present invention can operate a broadband wavelength range and can reduce the occurrence of crosstalk caused by the broadband wavelength range. For example, by changing the position and/or the angle of the wavelength dispersive element 4, the position control mechanism 7 can change the wavelength range to be separated by the wavelength dispersive element 4 from one band to another band among wavelength ranges used for optical communication including the T-band (238 THz to 300 THz), the O-band (220 THz to 238 THz), the E-band (205 THz to 220 THz), the S-band (196 THz to 205 THz), the C-band (191.5 THz to 196 THz), the L-band (184.5 THz to 191.5 THz), and the U-band (179 THz to 184.5 THz).

In addition, a change in the position of the wavelength dispersive element 4 refers to a change in the emission direction of the light having each of the wavelength components separated by the wavelength dispersive element 4 with respect to the deflection unit 6. For example, in a case where the wavelength dispersive element 4 has a configuration where a diffraction angle changes in a plane, the wavelength dispersive element 4 may be configured to be translated.

### [Wavelength Dispersive Element]

As the wavelength dispersive element, a well-known element can be used, and examples thereof include a prism, a surface relief diffraction grating, a liquid crystal diffraction element, a dielectric multi-layer film, and a cholesteric reflecting layer. A combination of the elements may be used. For example, a prism and a surface relief diffraction grating, a prism and a liquid crystal diffraction element, or a surface relief diffraction grating and a liquid crystal diffraction grating may be used in combination and integrated by bonding or lamination. From the viewpoint of excellent separability for near infrared light mainly used for optical cable communication, a surface relief diffraction grating, a liquid crystal diffraction element, a dielectric multi-layer film, or a cholesteric reflecting layer is preferable. In addition, from the viewpoints that higher-order light is small and the wavelength dependence of diffraction efficiency is low, as described below, it is more preferable to apply any one of a liquid crystal diffraction element or a cholesteric reflecting layer that includes an optically-anisotropic layer having a liquid crystal alignment pattern where an orientation of an optical axis derived from a liquid crystal compound changes while continuously rotating in at least one in-plane direction. From the viewpoints that a spatial separation distance between wavelength channels is large and crosstalk between channels can be reduced, it is preferable to apply any one of a liquid crystal diffraction element or a cholesteric reflecting layer that includes an optically-anisotropic layer having a liquid crystal alignment pattern where an orientation of an optical axis derived from a liquid crystal compound changes while continuously rotating in at least one in-plane direction.

### [Position Control Mechanism]

As the position control mechanism that reversibly changes a position or an angle of the wavelength dispersive element or both the position and the angle with respect to the optical input port, a mechanism that rotates the wavelength dispersive element around one axis may be used, or a mechanism that applies a linear motion to the wavelength dispersive element may be used. As the mechanism that controls the motion, a well-known unit such as a stepping motor or a linear motor can be adopted.

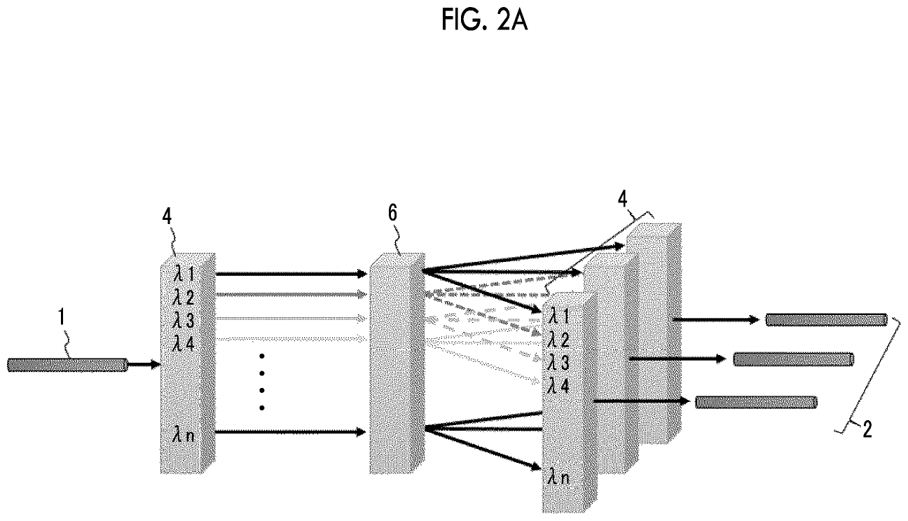

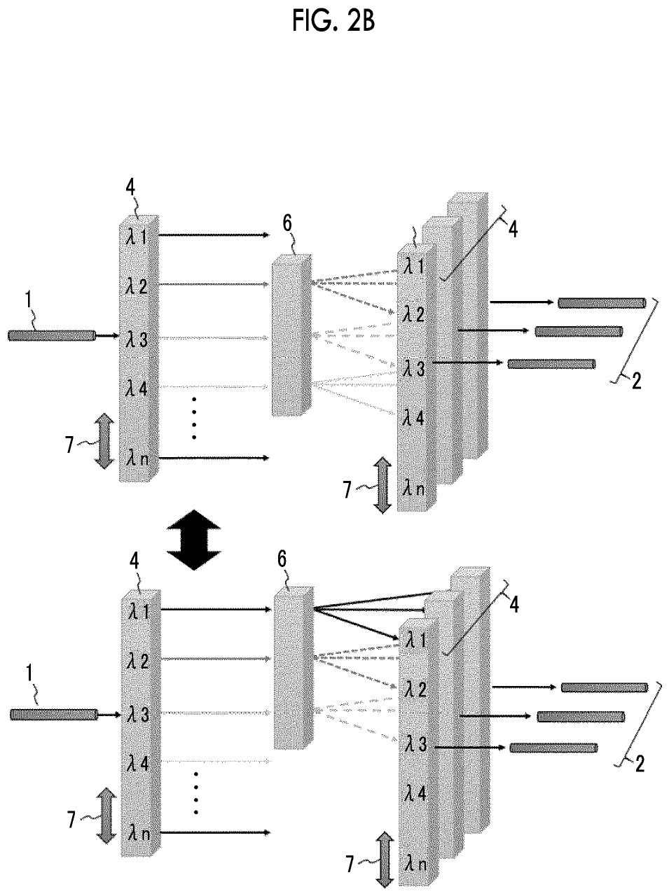

The function of the position control mechanism will be conceptually described using FIGS. 2a and 2b. The description will be made using FIGS. 2a and 2b showing an example of a drop wavelength selective switch including one optical input port and a plurality of optical output ports. However, the effects are also the same as those of an add wavelength selective switch including a plurality of optical input ports and one optical output port or an add-drop wavelength selective switch including a plurality of optical input ports and a plurality of optical output ports. In addition, FIGS. 2a and 2b show the wavelength dispersive element 4 that spatially separates incident light for each of wavelengths and the wavelength dispersive element 4 as a multiplexing unit that multiplexes two or more of light components having wavelengths deflected by the deflection unit 6, respectively. However, the wavelength dispersive element 4 may also function as the multiplexing unit. In addition, in FIGS. 2a and 2b, three wavelength dispersive elements 4 as multiplexing units are shown. Actually, however, the action as a multiplexing unit is exhibited at different positions in a plane of one wavelength dispersive element 4.

In the wavelength selective switch in the related art shown in FIG. 2a, the wavelength dispersive element 4 is fixed to the deflection unit 6. The physical size of the deflection unit 6 described below has an upper limit. Therefore, in order to correspond to the desired number of wavelength channels, the physical distance between the wavelength channels incident into the deflection unit 6 needs to be narrowed. However, in a case where a spatial modulator including pixels is used as the deflection unit 6, the width of the pixel pitch also has a lower limit. Therefore, in a case where the channel interval is close to the pixel pitch, crosstalk between the channels is concerned.

On the other hand, in the configuration of the present invention shown in FIG. 2b, the wavelength dispersive element 4 is movable by the position control mechanism 7, and thus the corresponding wavelength range of the device can be changed depending on input and output wavelength ranges. With the configuration where the wavelength dispersive element 4 is reversibly movable, even in a case where it is desired to operate a broadband wavelength range, the broadband wavelength range can be smoothly dealt with by operating the wavelength ranges at time intervals. In FIG. 2b, as the motion of the wavelength dispersive element 4, only the linear motion is shown. However, this motion is conceptual, and regarding the motion of the wavelength dispersive element 4 that is actually controlled by the position control mechanism 7, the angle or the position or both of the angle and the position may be controlled as described above.

The latitude and the resolution of the angle and the position in the control can be appropriately designed in consideration of the spatial separability of the wavelength dispersive element to be used, the optical path length from the wavelength dispersive element to the deflection unit, the size of the deflection unit, the width of the pixel pitch, and the like.

### [Deflection Unit]

The deflection unit includes a spatial phase modulator. The spatial phase modulator is a device that can change the phase of light to be reflected (to be transmitted in the case of a transmission type) depending on a spatial position on the spatial phase modulator where the light is reflected. By spatially controlling the phase of the light, the orientation (deflection) of the light can also be controlled.

As the spatial phase modulator, a liquid crystal optical element represented by a micromirror device or a liquid crystal on silicon (LCOS) can be used. From the viewpoint of easily adopting a configuration where three or more routes are provided, the spatial phase modulator using LCOS is preferable. With the configuration where three or more routes are provided, the degree of freedom of network policy (connection configuration) that can be formed is significantly increased, which can contribute to improvement of the internal network of a data center.

Examples of the LCOS include a configuration where a fine electrode for phase modulation that reflects light with high efficiency is formed on a silicon substrate and a glass substrate is mounted with a spacer interposed therebetween. A liquid crystal material for deflection control is sealed in a space surrounded by the glass substrate, the spacer, and the silicon substrate. The thicknesses and the like of the liquid crystal material to be sealed and the spacer are selected such that the phase of light in a communication wavelength band (184.5 to 238 THz) can be changed by 2π or more. In addition, a transparent thin film electrode for ground (GND) is provided in advance on both surfaces of the glass substrate. As the transparent electrode material, ITO is widely used.

### [Back-End Optical System]

The back-end optical system that can be included in the present invention can be configured by appropriately combining various optical elements such as a lens, a prism, a microlens array, an aperture, a filter, or a retardation plate.

In a case where the LCOS is used as the spatial phase modulator, the LCOS has polarization dependence, and thus light incident from the wavelength dispersion unit to the deflection unit is preferably polarized light and more preferably linearly polarized light. From this viewpoint, it is preferable that the above-described back-end optical system is configured to include an optical element that controls the polarization state.

The optical element that controls the polarization state may be an element that allows transmission of only a specific polarized light component and removes the other polarized light component by absorption or reflection. As the optical element, for example, an absorptive linear polarizer, a reflective linear polarizer, or a reflective circular polarizer can be applied. Examples of the absorptive linear polarizer include a material where iodine or a dichroic colorant is aligned and included in an organic material and an absorptive wire grid polarizer. Examples of the reflective linear polarizer include a reflective wire grid polarizer and a stretched multi-layer polymer film (for example, that is commercially available from 3M as DBEF (trade name) or APF (trade name)). Examples of the reflective circular polarizer include a cholesterically aligned liquid crystal material.

In addition, the optical element that controls the polarization state may be an element that spatially separates incident light depending on each of polarized light components. As the optical element, a Wollaston prism, a Rochon prism, a Brewster window, a polarization beam splitter, or a liquid crystal diffraction element that includes an optical functional layer having a liquid crystal alignment pattern where an optical axis derived from a liquid crystal compound changes in a plane can be used.

In a case where there is a difference in optical path length between wavelength channels in a range from the optical input port to the optical output port, a temporal mismatch occurs between the channels, which may cause a defect during signal reproduction. Therefore, it is preferable that the back-end optical system is designed such that there is no difference in optical path between wavelength channels.

### [Front-End Optical System]

As in the above-described back-end optical system, the front-end optical system that can be included in the present invention can be configured by appropriately combining various optical elements such as a lens, a prism, a microlens array, an aperture, a filter, or a retardation plate.

In a case where an optical element having polarization selectivity is used as the wavelength dispersive element, light incident from the optical input port to the wavelength dispersion unit is preferably polarized light. From this viewpoint, it is preferable that the above-described front-end optical system is configured to include an optical element that controls the polarization state.

As the optical element that controls the polarization state, an element that allows transmission of only a specific polarized light component and removes the other polarized light component by absorption or reflection or an element that spatially separates incident light depending on each of polarized light components can be used, and examples thereof are the same as those described above regarding the back-end optical system.

In addition, as described above regarding the back-end optical system, in a case where there is a difference in optical path length between wavelength channels in a range from the optical input port to the optical output port, a temporal mismatch occurs between the channels, which may cause a defect during signal reproduction. Therefore, it is preferable that the front-end optical system is designed such that there is no difference in optical path between wavelength channels.

A configuration where the front-end optical system compensates for the difference in optical path occurring in the optical path from the wavelength dispersive element to the back-end optical system and the deflection unit is more preferable.

### <Liquid Crystal Diffraction Element>

As the wavelength dispersive element of the wavelength selective switch according to the embodiment of the present invention, a liquid crystal diffraction element (liquid crystal optical element) that includes an optically-anisotropic layer (optical functional layer) having a liquid crystal alignment pattern where an optical axis derived from a liquid crystal compound changes in a plane can be used. Examples of the liquid crystal diffraction element include a transmissive liquid crystal diffraction element shown in FIG. 2 of JP2017-522601A and a reflective liquid crystal diffraction element shown in FIG. 4 of JP2017-522601A.

The liquid crystal diffraction element is a thin sheet-like element where a liquid crystal compound (compound including mesogen) is immobilized in a predetermined alignment state. In the liquid crystal diffraction element, optionally, a retardation layer, a prism layer, and a microlens layer can be used in combination.

In the wavelength selective switch according to the embodiment of the present invention, by using the liquid crystal diffraction element as the wavelength dispersive element, as compared to a prism or a surface relief diffraction grating (SRG) known in the related art, the spatial separation width between wavelength channels can be increased while the liquid crystal diffraction element is a thin and small element, and crosstalk between channels can be reduced from this viewpoint. In addition, this configuration is also preferable from the viewpoint that the diffraction efficiency is high and insertion loss can be reduced.

The liquid crystal diffraction element (optically-anisotropic layer) having the liquid crystal alignment pattern where an optical axis of a liquid crystal compound changes in a plane can be obtained by immobilizing the liquid crystal compound in a predetermined alignment state.

The alignment state may be immobilized using an electric field, a magnetic field, or the like, or may be immobilized using phase transition, crosslinking, polymerization, or the like of the liquid crystal compound.

In a case where the alignment state is immobilized using an electric field, a magnetic field, or the like, switching between ON and OFF and spatial separation of beams may be adjusted by controlling an electric field or a magnetic field to be applied. In a case where the alignment state is immobilized using phase transition, crosslinking, polymerization, or the like of the liquid crystal compound, various liquid crystal compounds can be used as the liquid crystal compound. From the viewpoint that stable optical characteristics can be maintained for a long period of time, a polymerizable liquid crystal compound is preferably used. It is more preferable that the liquid crystal diffraction element used in the present invention is an element obtained by aligning a composition including a polymerizable liquid crystal compound to a predetermined alignment state and immobilizing the alignment state by polymerization or crosslinking. Regarding a method of preparing the element, the element can be prepared using a method described in JP2017-522601A or WO2019/189852A.

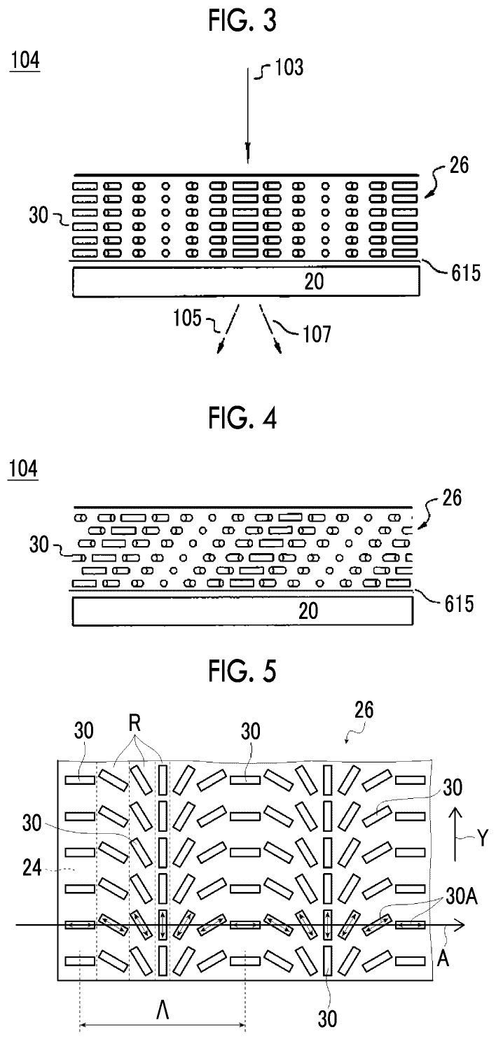

FIG. 3 is a conceptual diagram showing a liquid crystal diffraction element where an alignment state having a liquid crystal alignment pattern where an optical axis of a liquid crystal compound changes in a plane is immobilized.

In a liquid crystal diffraction element 104 shown in FIG. 3, an optically-anisotropic layer 26 as an optical functional layer is provided on a transparent substrate (support) 20 that is optionally provided. The optically-anisotropic layer 26 includes a liquid crystal compound 30 where an alignment state is immobilized along an optical axis (major axis direction of a rod in FIG. 3) that changes in any plane 615 crossing the optically-anisotropic layer 26. In addition, an alignment film 24 (not shown) is provided between a support 20 and the optically-anisotropic layer 26.

In the arrangement of the liquid crystal compound 30 where the alignment is immobilized as described above, a distribution of refractive index anisotropy is formed in the optically-anisotropic layer 26, a polarization selective diffraction action is exhibited with respect to signal light 103 from an optical fiber, and the incident signal light 103 is spatially separated into negative first-order light 105 and positive first-order light 107 at an angle corresponding to the wavelength.

In the liquid crystal diffraction element 104 of FIG. 3, typically, the optically-anisotropic layer that separates the incident signal light 103 into two circularly polarized light components having different rotation directions is provided. However, in a case where a polarization multiplexing mode is a multiplexing mode of linearly polarized light components orthogonal to each other, by adding an incidence-side λ/4 wave plate and an emission-side λ/4 wave plate (not shown), the two multiplexed linearly polarized light components can be spatially separated and extracted. Regarding this point, the same can also be applied to the example shown in FIG. 3 described below.

The alignment state and the polarization states of negative first-order light and first-order light (or zero-order light may be used) that are spatially separated can be analyzed using Jones Calculus (R. C. Jones, J. Opt. Soc. Am. 31, 488, 1941) described in JP2004-341024A, and only the negative first-order light and the first-order light can be used by appropriately designing the alignment state. As the wavelength dispersive element, an aspect where only first-order light is used is preferable.

In addition, as shown in FIG. 4, in the liquid crystal diffraction element 104, the optically-anisotropic layer 26 is formed of a composition including a liquid crystal compound, and has a liquid crystal alignment pattern in which an orientation of an optical axis derived from the liquid crystal compound changes while continuously rotating in at least one in-plane direction. The liquid crystal compound (optical axis) may also change while rotating in a thickness direction.

### (Support)

In the liquid crystal diffraction element 104, the support 20 supports the alignment film 24 and the optically-anisotropic layer 26.

As the support 20, various sheet-like materials (films and plate-like materials) can be used as long as these materials can support the alignment film 24 and the optically-anisotropic layer 26.

As the support 20, a transparent support is preferable, and examples thereof include a polyacrylic resin film such as polymethyl methacrylate, a cellulose resin film such as cellulose triacetate, a cycloolefin polymer film (for example, trade name “ARTON”, manufactured by JSR Corporation; or trade name “ZEONOR”, manufactured by Zeon Corporation), polyethylene terephthalate (PET), polycarbonate, and polyvinyl chloride. The support is not limited to a flexible film and may be a non-flexible substrate such as a glass substrate.

The thickness of the support 20 is not particularly limited and may be appropriately set depending on the use of the liquid crystal diffraction element 104, a material for forming the support 20, and the like in a range where the alignment film and the optically-anisotropic layer can be supported.

The thickness of the support 20 is preferably 1 to 1000 μm, more preferably 3 to 250 μm, and still more preferably 5 to 150 μm.

### (Alignment Film)

In the liquid crystal diffraction element 104, the alignment film 24 may be formed on a surface of the support 20.

The alignment film 24 is an alignment film for aligning the liquid crystal compound 30 to the predetermined liquid crystal alignment pattern during the formation of the optically-anisotropic layer 26 of the liquid crystal diffraction element 104.

In FIG. 3 or the like, a rod-like liquid crystal compound is shown as the liquid crystal compound 30.

As described above, in the transmissive liquid crystal diffraction element 104 in the example shown in the drawing, the optically-anisotropic layer 26 has a liquid crystal alignment pattern in which an orientation of an optical axis 30A (refer to FIG. 5) derived from the liquid crystal compound 30 changes while continuously rotating in one in-plane direction (in the drawing, an arrow A direction).

Accordingly, the alignment film of the liquid crystal diffraction element 104 is formed such that the optically-anisotropic layer 26 can form the liquid crystal alignment pattern.

In addition, in the present invention, in a case where the liquid crystal compound 30 is a rod-like liquid crystal compound, the optical axis 30A of the liquid crystal compound 30 refers to a molecular major axis of the rod-like liquid crystal compound. On the other hand, in a case where the liquid crystal compound 30 is a disk-like liquid crystal compound, the optical axis 30A of the liquid crystal compound 30 refers to an axis parallel to the normal direction (orthogonal direction) with respect to a disk plane of the disk-like liquid crystal compound.

In the following description, “the orientation of the optical axis 30A rotates” will also be simply referred to as “the optical axis 30A rotates”.

As the alignment film, various well-known films can be used.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as o-tricosanoic acid, dioctadecylmethylammonium chloride, or methyl stearate.

The alignment film formed by a rubbing treatment can be formed by rubbing a surface of a polymer layer with paper or fabric in a given direction multiple times.

As the material used for the alignment film, for example, a material for forming polyimide, polyvinyl alcohol, a polymer having a polymerizable group described in JP1997-152509A (JP-H9-152509A), or an alignment film such as JP2005-97377A, JP2005-99228A, and JP2005-128503A is preferable.

In the liquid crystal diffraction element 104, the alignment film is suitably used as a so-called photo-alignment film obtained by irradiating a photo-alignment material with polarized light or non-polarized light. That is, in the liquid crystal diffraction element 104, a photo-alignment film that is formed by applying a photo-alignment material to the support 20 is suitably used as the alignment film 24.

The irradiation of polarized light can be performed in a direction perpendicular or oblique to the photo-alignment film, and the irradiation of non-polarized light can be performed in a direction oblique to the photo-alignment film.

The thickness of the alignment film is not particularly limited. The thickness with which a required alignment function can be obtained may be appropriately set depending on the material for forming the alignment film.

The thickness of the alignment film is preferably 0.01 to 5 μm and more preferably 0.05 to 2 μm.

A method of forming the alignment film is not limited. Any one of various well-known methods corresponding to a material for forming the alignment film can be used.

For example, a method including: applying the alignment film to a surface of the support 20; drying the applied alignment film; and exposing the alignment film to laser light to form an alignment pattern can be used.

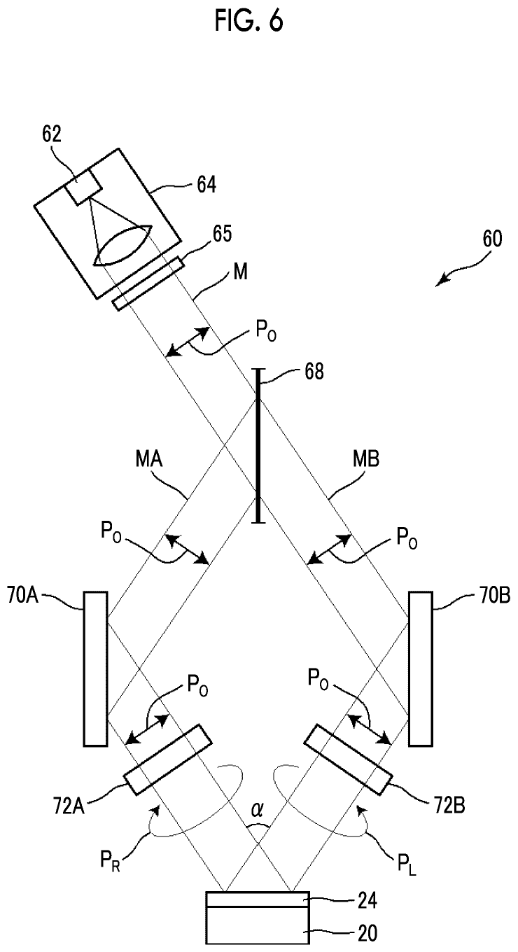

FIG. 6 conceptually shows an example of an exposure device that exposes the alignment film 24 to form the above-described alignment pattern.

An exposure device 60 shown in FIG. 6 includes: a light source 64 including a laser 62; an λ/2 plate 65 that changes a polarization direction of laser light M emitted from the laser 62; a polarization beam control element 68 that separates the laser light M emitted from the laser 62 into two beams MA and MB; mirrors 70A and 70B that are disposed on optical paths of the separated two beams MA and MB; and λ/4 plates 72A and 72B.

The light source 64 emits linearly polarized light P₀. The λ/4 plate 72A converts the linearly polarized light P₀ (beam MA) into right circularly polarized light P_{R}, and the λ/4 plate 72B converts the linearly polarized light P₀ (beam MB) into left circularly polarized light P_{L}.

The support 20 including the alignment film 24 on which the alignment pattern is not yet formed is disposed at an exposed portion, the two beams MA and MB intersect and interfere with each other on the alignment film 24, and the alignment film 24 is irradiated with and exposed to the interference light.

Due to the interference in this case, the polarization state of light with which the alignment film 24 is irradiated periodically changes according to interference fringes. As a result, an alignment film (hereinafter, also referred to as “patterned alignment film”) having an alignment pattern in which the alignment state changes periodically is obtained.

In the exposure device 60, by changing an intersecting angle α between the two beams MA and MB, the period of the alignment pattern can be adjusted. That is, by adjusting the intersecting angle α in the exposure device 60, in the alignment pattern in which the optical axis 30A derived from the liquid crystal compound 30 continuously rotates in the one direction, the length (single period A described below) of the single period over which the optical axis 30A rotates by 180° in the one direction in which the optical axis 30A rotates can be adjusted.

By forming the optically-anisotropic layer 26 on the alignment film 24 having the alignment pattern in which the alignment state periodically changes, as described below, the optically-anisotropic layer 26 having the liquid crystal alignment pattern in which the optical axis 30A derived from the liquid crystal compound 30 continuously rotates in the one direction can be formed.

In addition, by rotating the optical axes of the λ/4 plates 72A and 72B by 90°, respectively, the rotation direction of the optical axis 30A can be reversed.

As described above, the patterned alignment film has an alignment pattern to obtain the liquid crystal alignment pattern in which the liquid crystal compound is aligned such that the orientation of the optical axis of the liquid crystal compound in the optically-anisotropic layer 26 formed on the patterned alignment film changes while continuously rotating in at least one in-plane direction.

In a case where an axis along the orientation in which the liquid crystal compound is aligned is an alignment axis, it can be said that the patterned alignment film has an alignment pattern in which the orientation of the alignment axis changes while continuously rotating in at least one in-plane direction.

The alignment axis of the patterned alignment film can be detected by measuring absorption anisotropy. For example, in a case where the amount of light transmitted through the patterned alignment film is measured by irradiating the patterned alignment film with linearly polarized light while rotating the patterned alignment film, it is observed that an orientation in which the light amount is the maximum or the minimum gradually changes in the one in-plane direction.

In the liquid crystal diffraction element 104, the alignment film 24 is provided as a preferable aspect and, as described above, is not a configuration requirement.

For example, the following configuration can also be adopted, in which, by forming the alignment pattern on the support 20 using a method of rubbing the support 20, a method of processing the support 20 with laser light or the like, or the like, the optically-anisotropic layer 26 or the like as the liquid crystal alignment pattern in which the orientation of the optical axis 30A derived from the liquid crystal compound 30 changes while continuously rotating in the one direction.

### (Optically-Anisotropic Layer)

In the liquid crystal diffraction element 104 shown in FIG. 3, the optically-anisotropic layer 26 is formed on a surface of the alignment film 24.

As described above, in the liquid crystal diffraction element 104, the optically-anisotropic layer 26 is formed of a composition including the liquid crystal compound.

In a case where an in-plane retardation value is set as λ/2, the optically-anisotropic layer 26 has a function of a general λ/2 plate, that is, a function of imparting a phase difference of a half wavelength, that is, 1800 to two linearly polarized light components in light incident into the optically-anisotropic layer and are orthogonal to each other. The liquid crystal diffraction element 104 (optically-anisotropic layer 26) bends incident circularly polarized light and converts the turning direction of the circularly polarized light. In addition, the liquid crystal diffraction element 104 (optically-anisotropic layer 26) bends incident circularly polarized light in the opposite orientation direction according to the turning direction of the incident circularly polarized light.

The optically-anisotropic layer 26 has the liquid crystal alignment pattern where the orientation of the optical axis 30A derived from the liquid crystal compound 30 changes while continuously rotating in one direction (the arrow A direction in FIG. 5 or the like) of the optically-anisotropic layer.

The optical axis 30A derived from the liquid crystal compound 30 is an axis having the highest refractive index in the liquid crystal compound 30, that is, a so-called slow axis. For example, in a case where the liquid crystal compound 30 is a rod-like liquid crystal compound, the optical axis 30A is along a rod-like major axis direction.

In the following description, the optical axis 30A derived from the liquid crystal compound 30 will also be referred to as “the optical axis 30A of the liquid crystal compound 30” or “the optical axis 30A”.

FIG. 5 is a schematic diagram showing an alignment state of the liquid crystal compound 30 in a plane of a main surface of the optically-anisotropic layer 26. The main surface is the maximum surface of a sheet-like material (a film, a plate-like material, or a layer).

As described above, the optically-anisotropic layer 26 has the liquid crystal alignment pattern where the optical axis 30A changes while continuously rotating in the one direction indicated by the arrow A.

In the optically-anisotropic layer 26, the liquid crystal compound 30 is two-dimensionally aligned in a plane along the one direction indicated by the arrow A and a Y direction orthogonal to the arrow A direction. In FIGS. 5 and 6 described below, the Y direction is a direction orthogonal to the paper plane.

In the following description, “one direction indicated by the arrow A” will also be simply referred to as “arrow A direction”.

The plan view is a view in a case where the optically-anisotropic layer 26 is seen from a thickness direction (laminating direction of the respective layers (films)). In other words, the plan view is a view in a case where the optically-anisotropic layer 26 is seen from a direction orthogonal to the main surface.

In addition, in FIG. 5, in order to clarify the configuration of the liquid crystal diffraction element 104, only the liquid crystal compound 30 on the surface of the alignment film 24 is shown. However, in the thickness direction, as shown in FIG. 3, the optically-anisotropic layer 26 has the structure in which the liquid crystal compound 30 is laminated on the liquid crystal compound 30 of the surface of the alignment film.

The optically-anisotropic layer 26 has the liquid crystal alignment pattern in which the orientation of the optical axis 30A derived from the liquid crystal compound 30 changes while continuously rotating in the arrow A direction in a plane of the optically-anisotropic layer 26.

Specifically, “the orientation of the optical axis 30A of the liquid crystal compound 30 changes while continuously rotating in the arrow A direction (the predetermined one direction)” represents that an angle between the optical axis 30A of the liquid crystal compound 30, which is arranged in the arrow A direction, and the arrow A direction varies depending on positions in the arrow A direction, and the angle between the optical axis 30A and the arrow A direction sequentially changes from θ to θ+180° or θ−180° in the arrow A direction.

A difference between the angles of the optical axes 30A of the liquid crystal compound 30 adjacent to each other in the arrow A direction is preferably 45° or less, more preferably 15° or less, and still more preferably less than 15°.

On the other hand, regarding the liquid crystal compound 30 forming the optically-anisotropic layer 26, the liquid crystal compounds 30 having the same orientation of the optical axes 30A are arranged at regular intervals in the Y direction orthogonal to the arrow A direction, that is, the Y direction orthogonal to the one direction in which the optical axis 30A continuously rotates.

In other words, regarding the liquid crystal compound 30 forming the optically-anisotropic layer 26, in the liquid crystal compounds 30 arranged in the Y direction, angles between the orientations of the optical axes 30A and the arrow A direction are the same.

In the liquid crystal alignment pattern in which the optical axis 30A continuously rotates in the one direction, a length (distance) over which the optical axis 30A of the liquid crystal compound 30 rotates by 180° is set as a length A of the single period in the liquid crystal alignment pattern.

That is, in the optically-anisotropic layer 26 shown in FIGS. 3 and 5, the length (distance) over which the optical axis 30A of the liquid crystal compound 30 rotates by 180° in the arrow A direction in which the orientation of the optical axis 30A changes while continuously rotating in a plane is set as the length A of the single period in the liquid crystal alignment pattern. In other words, the length of the single period in the liquid crystal alignment pattern is defined as the distance between θ and θ+180° that is a range of the angle between the optical axis 30A of the liquid crystal compound 30 and the arrow A direction.

That is, a distance between centers of two liquid crystal compounds 30 in the arrow A direction is the length Λ of the single period, the two liquid crystal compounds having the same angle in the arrow A direction. Specifically, as shown in FIG. 5, a distance of centers in the arrow A direction of two liquid crystal compounds 30 in which the arrow A direction and the direction of the optical axis 30A match with each other is the length Λ of the single period.

In the following description, the length Λ of the single period will also be referred to as “single period Λ”.

In the liquid crystal diffraction element 104, in the liquid crystal alignment pattern of the optically-anisotropic layer 26, the single period A is repeated in the arrow A direction, that is, in the one direction in which the orientation of the optical axis 30A changes while continuously rotating. In addition, the liquid crystal diffraction element 104 (optically-anisotropic layer 26) is a liquid crystal diffraction element, and the single period Λ is the period (single period) of the diffraction structure.

As described above, in the liquid crystal compounds arranged in the Y direction orthogonal to the arrow A direction in the optically-anisotropic layer 26, the angles between the optical axes 30A and the arrow A direction, that is, the one direction in which the orientation of the optical axis of the liquid crystal compound 30 rotates are the same. Regions where the liquid crystal compounds 30 in which the angles between the optical axes 30A and the arrow A direction are the same are disposed in the Y direction will be referred to as “regions R”.

In this case, it is preferable that an in-plane retardation (Re) value of each of the regions R is a half wavelength, that is, λ/2. The in-plane retardation is calculated from the product of a difference Δn in refractive index generated by refractive index anisotropy of the region R and the thickness of the optically-anisotropic layer. Here, the difference in refractive index generated by refractive index anisotropy of the region R in the optically-anisotropic layer is defined by a difference between a refractive index of a direction of an in-plane slow axis of the region R and a refractive index of a direction orthogonal to the direction of the slow axis. That is, the difference Δn in refractive index generated by refractive index anisotropy of the region R is the same as a difference between a refractive index of the liquid crystal compound 30 in the direction of the optical axis 30A and a refractive index of the liquid crystal compound 30 in a direction perpendicular to the optical axis 30A in a plane of the region R. That is, the difference Δn in refractive index is the same as the difference in refractive index of the liquid crystal compound.

By changing the single period A of the liquid crystal alignment pattern formed in the optically-anisotropic layer 26, the refraction angle and wavelength selectivity of transmitted light can be adjusted. Specifically, as the single period A of the liquid crystal alignment pattern decreases, light components transmitted through the liquid crystal compounds 30 adjacent to each other more strongly interfere with each other. Therefore, the transmitted light can be more largely refracted. In addition, the refraction angle of light by the optically-anisotropic layer 26 varies depending on the wavelength of incident light, and as the wavelength becomes shorter, the refraction angle decreases. The refraction angle with respect to the wavelength of incident light can be controlled depending on a change in the period A and the liquid crystal alignment pattern in the optically-anisotropic layer, and the spatial separation can be set to large by adjusting the period A and the liquid crystal alignment pattern to exhibit desired characteristics.

### <Cholesteric Reflecting Layer>

As the wavelength dispersive element of the wavelength selective switch according to the embodiment of the present invention, a reflective liquid crystal diffraction element that includes a cholesteric reflecting layer (cholesteric liquid crystal layer) having a liquid crystal alignment pattern in which an orientation of an optical axis derived from the liquid crystal compound changes while continuously rotating in at least one in-plane direction can be used.

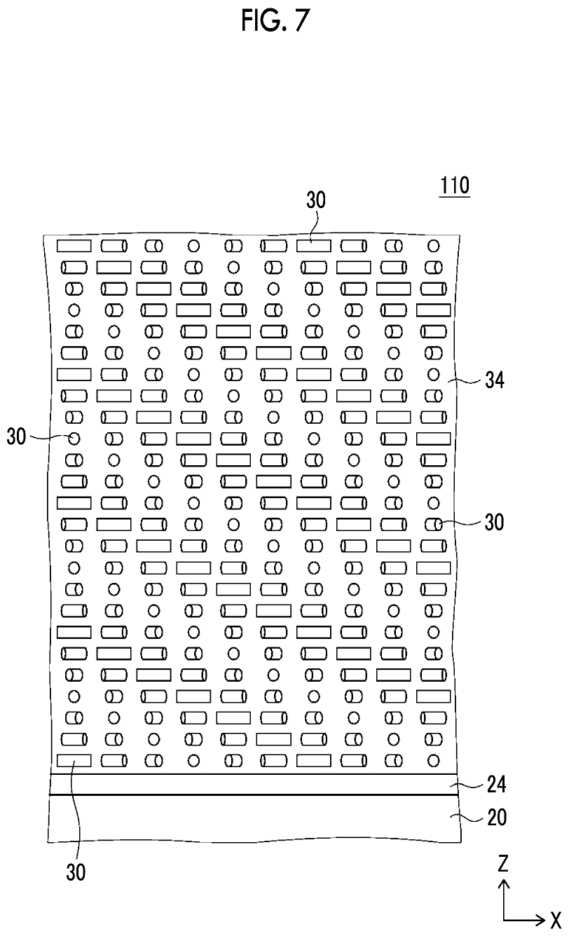

FIG. 7 is a diagram schematically showing an example of the reflective liquid crystal diffraction element. In addition, the plan view of the reflective liquid crystal diffraction element shown in FIG. 7 has the same configuration as the configuration shown in FIG. 5.

The reflective liquid crystal diffraction element shown in FIGS. 5 and 7 includes a cholesteric liquid crystal layer 34 that is obtained by immobilizing a cholesteric liquid crystalline phase and has a liquid crystal alignment pattern in which an orientation of an optical axis derived from a liquid crystal compound changes while continuously rotating in at least one in-plane direction. The cholesteric liquid crystal layer reflects one circularly polarized light having a selective reflection wavelength, and allows transmission of light in other wavelength ranges and other circularly polarized light. Accordingly, the diffraction element including the cholesteric liquid crystal layer is a reflective diffraction element.

In the example shown in FIG. 7, the reflective liquid crystal diffraction element includes the support 20, the alignment film 24, and the cholesteric liquid crystal layer 34. The support 20 and the alignment film 24 are the same as those of the transmissive liquid crystal diffraction element.

In the example shown in FIG. 7, the reflective liquid crystal diffraction element includes the support 20, the alignment film 24, and the cholesteric liquid crystal layer 34.

However, the present invention is not limited to this configuration. The reflective liquid crystal diffraction element may include only the alignment film 24 and the cholesteric liquid crystal layer 34 by peeling off the support 20. Alternatively, the reflective liquid crystal diffraction element may include only the cholesteric liquid crystal layer 34 by peeling off the support 20 and the alignment film 24.

As conceptually shown in FIG. 7, the cholesteric liquid crystal layer 34 has a helical structure in which the liquid crystal compound 30 is helically turned and laminated as in a cholesteric liquid crystal layer obtained by immobilizing a typical cholesteric liquid crystalline phase. In the helical structure, a configuration in which the liquid crystal compound 30 is helically rotated once (rotated by 360) and laminated is set as one helical pitch, and plural pitches of the helically turned liquid crystal compounds 30 are laminated.

As is well-known, the cholesteric liquid crystal layer obtained by immobilizing a cholesteric liquid crystalline phase has wavelength selective reflectivity, and the selective reflection wavelength range of the cholesteric liquid crystal layer depends on the length of one helical pitch described above in the thickness direction. Accordingly, in the configuration where wavelength selectivity is imparted to the cholesteric liquid crystal layer to diffract light having a wavelength that varies depending on each of the cholesteric liquid crystal layers, the selective reflection wavelength range of the cholesteric liquid crystal layer may be appropriately set by adjusting the helical pitch P of the cholesteric liquid crystal layer according to each of the cholesteric liquid crystal layers.

In addition, as in the above-described transmissive liquid crystal diffraction element, the cholesteric liquid crystal layer 34 has a liquid crystal alignment pattern in which an orientation of an optical axis derived from the liquid crystal compound changes while continuously rotating in at least one in-plane direction.

The cholesteric liquid crystal layer 34 having the liquid crystal alignment pattern reflects incident light in a direction different from specular reflection. For example, light incident from a direction perpendicular to the cholesteric liquid crystal layer 34 is reflected to be tilted in the arrow A direction.

For example, assuming that the cholesteric liquid crystal layer 34 selectively reflects right circularly polarized light of red light, in a case where light is incident into the cholesteric liquid crystal layer 34, the cholesteric liquid crystal layer 34 reflects only right circularly polarized light of red light and allows transmission of the other light.

Here, in the cholesteric liquid crystal layer 34, the optical axis 30A of the liquid crystal compound 30 changes while rotating in the arrow A direction (the one direction). In addition, the liquid crystal alignment pattern formed in the cholesteric liquid crystal layer 34 is a pattern that is periodic in the arrow A direction. Therefore, the right circularly polarized light R_{R} of red light vertically incident into the cholesteric liquid crystal layer 34 is reflected and diffracted in an orientation direction corresponding to the period of the liquid crystal alignment pattern, and the reflected right circularly polarized light R_{R} of red light is reflected and diffracted in a direction tilted in an orientation direction of an arrangement axis D with respect to an X-Y plane (the main surface of the cholesteric liquid crystal layer).

Accordingly, in the cholesteric liquid crystal layer 34, by appropriately setting the arrow A direction as the one direction in which the optical axis 30A rotates, the reflection direction (reflection orientation) of light can be adjusted.

In addition, in a case where circularly polarized light having the same wavelength and the same turning direction is reflected, by reversing the rotation direction of the optical axis 30A of the liquid crystal compound 30 toward the arrow A direction, the orientation direction of reflection of the circularly polarized light can be reversed.

For example, in a case where the rotation direction of the optical axis 30A toward the arrow A direction is clockwise and one circularly polarized light is reflected to be tilted in the arrow A direction, by setting the rotation direction of the optical axis 30A to be counterclockwise, one circularly polarized light is reflected to be tilted in a direction opposite to the arrow A direction.

Further, in the cholesteric liquid crystal layer having the same liquid crystal alignment pattern, the reflection direction is reversed according to the helical turning direction of the liquid crystal compound 30, that is, the turning direction of circularly polarized light to be reflected.

For example, in a case where the helical turning direction is right-twisted, the liquid crystal layer selectively reflects right circularly polarized light, and has the liquid crystal alignment pattern in which the optical axis 30A rotates clockwise in the arrow A direction. As a result, the right circularly polarized light is reflected to be tilted in the arrow A direction. In addition, for example, in a case where the helical turning direction is left-twisted, the liquid crystal layer selectively reflects left circularly polarized light, and has the liquid crystal alignment pattern in which the optical axis 30A rotates clockwise in the arrow A direction. As a result, the left circularly polarized light is reflected in a state where the light is tilted in a direction opposite to the arrow A direction.

In the cholesteric liquid crystal layer 34 having the liquid crystal alignment pattern, as the single period A decreases, the angle of reflected light with respect to the incidence light increases. That is, as the single period A decreases, reflected light is reflected to be largely tilted with respect to incidence light.

The diffraction angle by the cholesteric liquid crystal layer 34 having the liquid crystal alignment pattern varies depending on the wavelength of light. Specifically, as the wavelength of light increases, the angle of reflected light with respect to incidence light increases. Accordingly, the cholesteric liquid crystal layer 34 can separate incident light by diffracting (reflecting) the light at an angle that varies depending on the wavelength. In a case where the cholesteric liquid crystal layer 34 is used as the wavelength dispersive element 4, as shown in FIG. 1, by changing the angle of the cholesteric liquid crystal layer 34, an angle at which cholesteric light is incident changes, and thus the wavelength of light toward the deflection unit 6 changes. As a result, the wavelength range of light to be separated by the wavelength dispersive element 4 can be changed.

In addition, as described above, the cholesteric liquid crystal layer according to the embodiment of the present invention reflects and diffracts incident light at an angle that varies depending on each of the wavelengths. That is, the cholesteric liquid crystal layer needs to have a reflection wavelength range that is broad to a certain degree. On the other hand, a general cholesteric liquid crystal layer has wavelength selective reflectivity, and reflects light in a narrow band.

Accordingly, in order to widen the reflection wavelength range, it is preferable that the cholesteric liquid crystal layer according to the embodiment of the present invention has a structure in which the helical pitch changes in the thickness direction. Since the cholesteric liquid crystal layer has the structure in which the helical pitch changes in the thickness direction, the reflection wavelength range of the cholesteric liquid crystal layer can be widened. In addition, in order to widen the reflection wavelength range, it is also preferable to increase a birefringence index (An) of liquid crystal.

In the cholesteric liquid crystal layer where the helical pitch changes in the thickness direction, in a stripe pattern of bright portions and dark portions in a cross section observed with a scanning electron microscope (SEM), intervals of the bright portions and the dark portions vary in the thickness direction.

Alternatively, the reflective liquid crystal diffraction element according to the embodiment of the present invention may be configured to include a plurality of cholesteric liquid crystal layers having different helical pitches. In this case, each of the plurality of cholesteric liquid crystal layers has the liquid crystal alignment pattern, and reflects and diffracts light having a selective reflection wavelength in incident light. In addition, by making the diffraction angles by the cholesteric liquid crystal layers different from each other, the cholesteric liquid crystal layers reflect light at different angles (directions). In addition, depending on the selective reflection wavelength, the reflective diffraction element may be configured to include a cholesteric liquid crystal layer that reflects right circularly polarized light and a cholesteric liquid crystal layer that reflects left circularly polarized light, the cholesteric liquid crystal layers having the same selective reflection wavelength.

The cholesteric liquid crystal layer having the liquid crystal alignment pattern can be prepared using methods described in WO02019/131966A, WO2019/189852A, and the like.

### <Optical Cross-Connect Device>

An optical cross-connect device according to an embodiment of the present invention can be configured by including one or more wavelength selective switches according to the embodiment of the present invention described above and using a multicast switch and an electronic circuit for driving in combination. The optical cross-connect device according to the embodiment of the present invention can provide an optical cross-connect device that is useful in that it can smoothly deal with the operation of a broadband wavelength range and crosstalk is small such that insertion loss is small.

As a specific example, a configuration can be adopted in which the wavelength selective switch according to the embodiment of the present invention is mounted as a drop type on an optical input side of the optical cross-connect device, and after allowing the multicast switch to control each of separated beams, the wavelength selective switch according to the embodiment of the present invention is mounted as an add type on an optical output side of the optical cross-connect device. In the wavelength selective switch according to the embodiment of the present invention, the corresponding wavelength range is variable, and thus even in a case where the wavelength range operates flexibly depending on a traffic situation, the optimum performance can be always exhibited, which is preferable.

### EXPLANATION OF REFERENCES

1: optical input port
2: optical output port
3: front-end optical system
4: wavelength dispersive element
5: back-end optical system
6: deflection unit
7: position control mechanism
20: support
24: alignment film
26: optically-anisotropic layer
30: liquid crystal compound
30A: optical axis
34: cholesteric liquid crystal layer
60: exposure device
62: laser
64: light source
65: λ/2 plate
68: polarization beam control element
70A, 70B: mirror
72A, 72B: λ/4 plate
103: signal light
104: liquid crystal diffraction element
105: negative first-order light
107: first-order light
615: plane
Λ: single period
R: region
P₀: linearly polarized light
P_{L}: left circularly polarized light
P_{R}: right circularly polarized light
α: intersecting angle
M: laser light
MA, MB: beam

What is claimed is:

1. A wavelength selective switch comprising:
an optical input port;
an optical output port;
a wavelength dispersion unit that spatially separates light incident from the optical input port for each of wavelengths and emits the separated light such that an emission angle of the incident light varies for each of predetermined wavelength ranges; and
a deflection unit that couples light incident from the wavelength dispersion unit to the optical output port by deflecting the incident light such that a reflection angle or a transmission angle of the incident light is variable for each of wavelengths,
wherein the wavelength dispersion unit includes a wavelength dispersive element and a position control mechanism that reversibly changes a position or an angle of the wavelength dispersive element or both the position and the angle with respect to the optical input port.

2. The wavelength selective switch according to claim 1, further comprising:
a multiplexing unit that multiplexes two or more of light components having wavelengths deflected by the deflection unit.

3. The wavelength selective switch according to claim 2,
wherein the wavelength dispersion unit also functions as the multiplexing unit.

4. The wavelength selective switch according to claim 1,
wherein the wavelength dispersive element includes at least one of a prism, a surface relief diffraction grating, or a liquid crystal diffraction element.

5. The wavelength selective switch according to claim 4,
wherein the wavelength dispersive element is a liquid crystal diffraction element that includes an optically-anisotropic layer having a liquid crystal alignment pattern where an orientation of an optical axis derived from a liquid crystal compound changes while continuously rotating in at least one in-plane direction.

6. An optical cross-connect device comprising:
the wavelength selective switch according to claim 1.

7. An optical cross-connect device comprising:
the wavelength selective switch according to claim 2.

8. An optical cross-connect device comprising:
the wavelength selective switch according to claim 3.

9. An optical cross-connect device comprising:
the wavelength selective switch according to claim 4.

10. An optical cross-connect device comprising:
the wavelength selective switch according to claim 5.

11. An optical cross-connect device comprising:
the wavelength selective switch according to claim 6.
